(19) United States
(12) Patent Application Publication
(10) Pub. No.: US 2026/0230932 A1
(43) Pub. Date: Aug. 6, 2026

(54) SCHEDULING ENHANCEMENTS TO SUPPORT THE SENDING OF COLLECTED DATA

(71) Applicant: InterDigital Patent Holdings, Inc., Wilmington, DE (US)

(72) Inventors: Oumer Teyeb, Montreal (CA); Faris Alfarhan, Montreal (CA); Ghyslain Pelletier, Montreal (CA); Diana Pani, Montreal (CA); Yugeswar Deenoo Narayanan Thangaraj, Chalfont, PA (US); Dylan Watts, Montreal (CA)

(73) Assignee: InterDigital Patent Holdings, Inc., Wilmington, DE (US)

(21) Appl. No.: 19/046,415

(22) Filed: Feb. 5, 2025

(51) Int. Cl. H04W 28/22; H04W 72/0457; H04W 72/1268; H04W 72/56

(52) U.S. Cl. CPC H04W 28/22; H04W 72/0457; H04W 72/1268; H04W 72/56

(57) ABSTRACT

A wireless transmit/receive unit (WTRU) may receive configuration information. The configuration information may include one or more first conditions and/or one or more second conditions. The one or more conditions may be associated with a priority a logical channel. For example, the indication may indicate that the one or more conditions are associated with a priority of the logical channel. The WTRU may receive an uplink (UL) grant. Based on the one or more second conditions for example, the WTRU may determine parameters associated with a logical channel. The WTRU may determine data, for example based on the parameters associated with the logical channel. The WTRU may transmit the determined data, for example via one or more resources indicated the UL grant and/or based on the parameters that are associated with the logical channel.

### BACKGROUND

Artificial intelligence/machine learning (AI/ML) may be integrated into a network, for example a into fifth generation (5G) new radio (NR) network. AI/ML may enhance air-interface performance (e.g., improved throughput, robustness, accuracy or reliability, etc.) and/or reduce complexity/overhead. AI/ML may impact beam management, positioning, and CSI prediction.

Artificial intelligence (AI) may include behavior exhibited by machines that, for example may mimic cognitive functions to sense, reason, adapt, and/or act. An AI component may include the realization of behaviors and/or conformance to requirements by learning based on data, for example without explicit configuration of sequence of steps of actions. An AI component may enable learning complex behaviors. Complex behaviors may be difficult to specify and/or implement when using legacy methods.

Machine learning (ML) may include algorithms (e.g., types of algorithms) that solve a problem based on learning through experience (e.g., data), for example without being explicitly programmed (e.g., configuring a set of rules). ML may be a subset of AI. Different ML paradigms may be envisioned, for example based on the nature of data or feedback available to the learning algorithm. A supervised learning approach may involve learning a function that maps input to an output based on labeled training example. A (e.g., each) training example may include a pair. The pair may include an input and a corresponding output. An unsupervised learning approach may involve detecting patterns in the data with no pre-existing labels. A reinforcement learning approach may involve performing a sequence of actions in an environment, for example to maximize the cumulative reward. ML algorithms may be applied using a combination and/or interpolation of the approaches herein. For example, a semi-supervised learning approach may use a combination of a small amount of labeled data with a large amount of unlabeled data during training. Semi-supervised learning may fall between unsupervised learning (e.g., with no labeled training data) and supervised learning (e.g., with only labeled training data).

### SUMMARY

A WTRU may be configured to modify scheduling related parameters, for example of a logical channel associated with data collection (e.g., priority, PBR, BDS). The WTRU may modify the scheduling related parameters based on a set of conditions/thresholds. The conditions/threshold may include network conditions and/or WTRU conditions. Example network conditions may include radio signal level and/or congestion. Example WTRU conditions may include current level of buffer occupancy associated with the data collection, the activity/buffer level of other data radio bearers (DRBs), and/or the reception of a request to report collected data from a network and/or an OTT server, etc.

The WTRU may be configured to receive an uplink (UL) grant and/or indication/configuration (e.g., along with the grant, separately from the grant, etc.), for example that specifies if the grant is to be used for scheduling logical channels associated with data collection. The UL grant and/or indication/configuration may be received in configuration information. Additionally, or alternatively the UL grant and/or indication/configuration may specify how the grant is to be used for scheduling logical channels associated with data collection, for example a minimum/maximum percentage allocation, and/or only as a padding, etc.

A WTRU may receive configuration information. The configuration information may include one or more first conditions and/or one or more second conditions. The one or more conditions may be associated with a priority a logical channel. For example, the indication may indicate that the one or more conditions are associated with a priority of the logical channel. The WTRU may receive an uplink (UL) grant. Based on the one or more second conditions for example, the WTRU may determine parameters associated with a logical channel. The WTRU may determine data, for example based on the parameters associated with the logical channel. The WTRU may transmit the determined data, for example via one or more resources indicated the UL grant and/or based on the parameters that are associated with the logical channel.

The parameter associated with the logical channel may indicate a priority of the logical channel, a prioritized bit rate of the logical channel, and/or a bucket size duration of the logical channel. The indication of the one or more second conditions may include an indication of a volume of collected data. The WTRU may perform one or more of the following, for example when a volume of collected data exceeds a threshold value: increase a priority associated with the logical channel, increase a prioritized bit rate associated with the logical channel, and/or increase a bucket size duration associated with the logical channel.

The WTRU may determine the parameters that are associated with the logical channel, for example based on reception of a data collection reporting request, a congestion level of a network, a buffer level of another logical channel, and/or a signal level of serving cell. The configuration information may include an indication of the logical channel and/or a radio bearer associated with the logical channel. The WTRU may collect the data and/or transmit at least one packet data convergence protocol (PDCP) service data unit (SDU) including the data to a PDCP entity of the radio bearer associated with the logical channel.

The configuration information may include an indication to restrict scheduling of the logical channel. The WTRU may perform one or more of the following, for example based on the indication to restrict scheduling of the logical channel: not transmit the data based on the UL grant, transmit the data only if there is room in the UL grant after data of other logical channels has been scheduled, and/or allocate up to a maximum configured percentage of the UL grant to the data. The configuration information may include one or more first conditions. The WTRU may collect the data based on the one or more first conditions. The WTRU may determine a restriction level associated with the logical channel, for example based on a volume of collected data.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

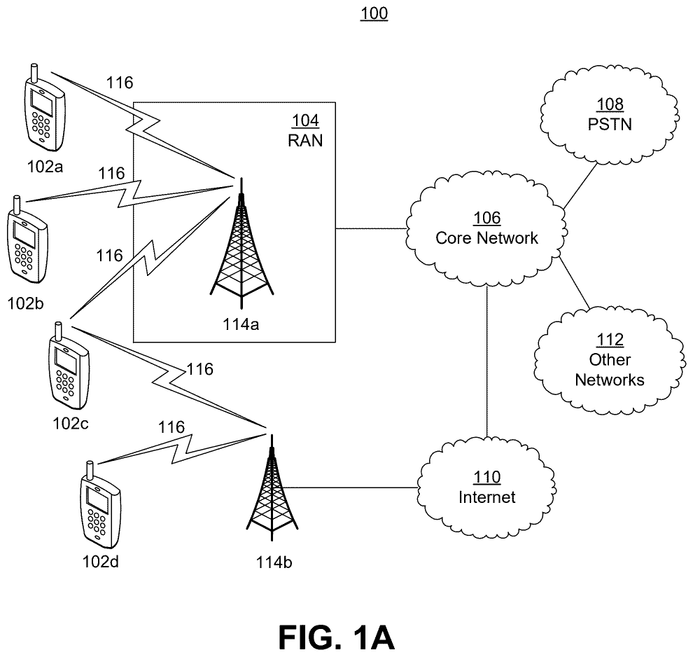

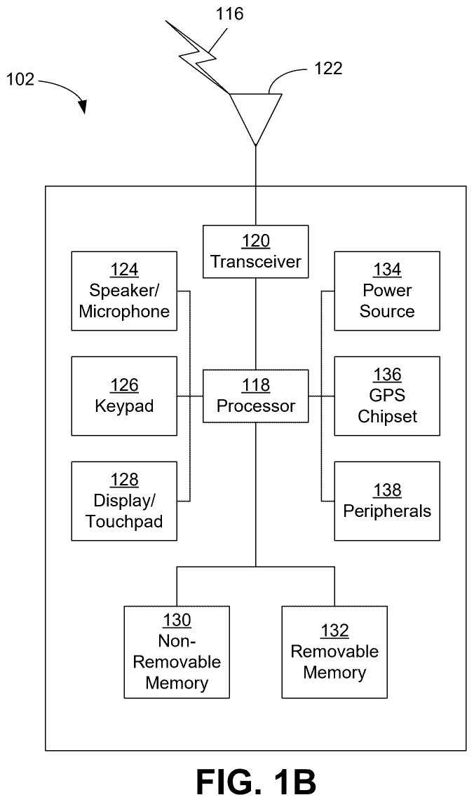

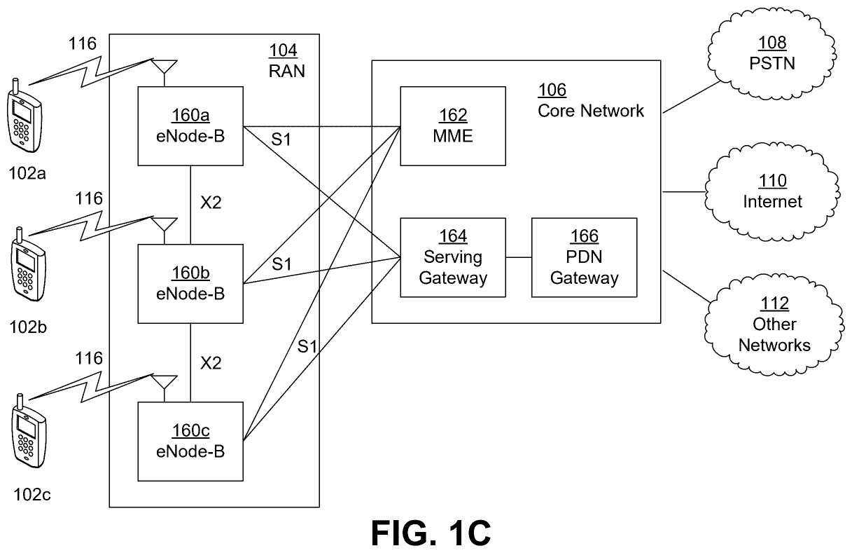

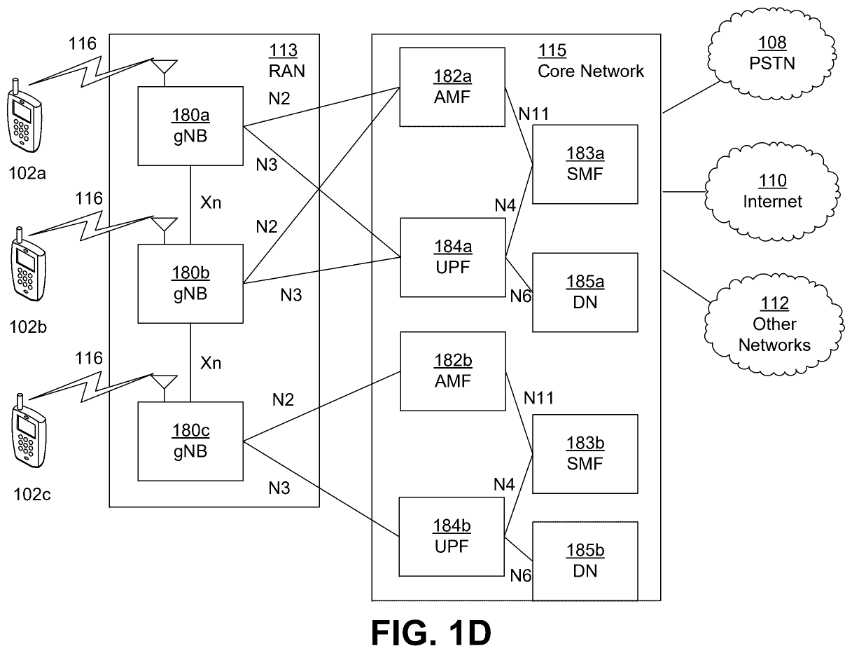

FIG. 1A is a diagram illustrating an example communications system 100 in which one or more disclosed embodiments may be implemented. The communications system 100 may be a multiple access system that provides content, such as voice, data, video, messaging, broadcast, etc. to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc. and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Framework for supporting use cases may include wireless transmit/receive unit (WTRU)-side and/or NW-side data collection. Data collection may be performed for purposes in life cycle management (LCM), for example for model training, model inference, model monitoring, model selection, and/or model update. Example purposes may have different requirements and/or potential specification impact.

Data collection may be used for training of a network side or a WTRU sided model. Data may be collected for the training of a network sided model, for example based on (e.g., immediate) minimization of drive test (MDT) (e.g., sent via RRC signaling). Additionally, or alternatively, a low priority signaling radio bearer (SRB) may be used. A WTRU may send an availability indication when data is available. A Network may request the collected data on demand (e.g. using UEInformationRequest/response messaging). Large amounts of data may be sent, for example in multiple requests, and/or one request followed by multiple responses, etc. A WTRU may stop/pause the data collection when a buffer limit is reached. A WTRU may indicate to the network before/when the buffer becomes full (e.g., a percentage of buffer size). A WTRU may send an indication of a power problem and/or to stop/pause the data collection. Periodic and/or event based logging may be supported (e.g., events based on radio conditions).

Data may be collected for the training of a WTRU sided model. For example a WTRU may collect and/or (e.g., directly) transfer training data to an over-the-top (OTT) server. The OTT server may be transparent or non-transparent. A WTRU may collect training data and/or transfer the training data to a core network (CN). The CN may transfer the training data to the OTT server. A WTRU may collect training data and/or transfers it to operations, administration, and maintenance (OAM). OAM may transfer the (e.g., needed) data to the OTT server.

Systems and methods herein may utilize uplink (UL) scheduling. A WTRU (e.g., in NR) may be provided with UL resources to transmit data, for example in a configured and/or dynamic fashion. Types of configured grants may include type 1 and type 2. For type 1 grants, RRC may provide a configured uplink grant, for example including its periodicity. The configured UL grant may be activated, for example when the WTRU receives the message (e.g., RRC message). For type 2 grants, RRC may define a periodicity of the uplink grant. The grant may activated and/or deactivated via physical downlink control channel (PDCCH) signaling, for example for type 2 grants.

Dynamic UL grants may be provided/indicated to the WTRU, for example via PDCCH(s). The WTRU may monitor UL and/or downlink (DL) scheduling, for example on PDCCH(S). A dynamically allocated uplink transmission may override a configured uplink grant in the same serving cell, for example if they overlap in time.

A scheduler, for example at the MAC of the WTRU, may have a rate control function. The rate control function may control such that UL resources/grants are shared properly among the bearers. For example, each logical channel (e.g., logical channels transfer RLC PDUs between the RLC and MAC layers) may be configured with a priority, a prioritized bit rate (PBR), and/or a buffer size duration (BSD). The rate control function may be an uplink logical channel prioritization (LCP) procedure. The uplink LCP procedure may be utilized such that the WTRU serves the logical channels in a sequence. For example the sequence may include (e.g., all) relevant logical channels in decreasing priority order up to their PBR. The sequence may (e.g., then) include (e.g., all) relevant logical channels in decreasing priority order for the remaining resources assigned by the grant.

Prioritized bit rates may be served first, and for example the remaining capacity may (e.g., then) be shared between the remaining logical channels in their priority order. Maximum bit rates defined may (e.g., therefore) not be exceeded. If several logical channels have the same priority for example, the WTRU may serve these logical channels equally. If PBRs are all set to zero, the relevant logical channels served in decreasing priority order up to their PBR may be skipped and the logical channels may be served in strict priority order. For example the WTRU may maximize transmission of higher priority data. There may be logical channel mapping restrictions that, for example provide an indication to the WTRU of which logical channels are relevant for the grant received. If no mapping restrictions are configured for example, all logical channels may be considered.

Systems and methods may utilize traffic shaping and/or regulation. In uplink transmission for example, a traffic scheduling regulator, S may be used to characterize traffic transmission rates at the WTRU. The traffic scheduling regulator S may be used to determine the worst-case bounds on delay and/or a backlog in the WTRU buffer. A may describe a cumulative arrival function of traffic for a given flow to the WTRU's buffer. D may describe a transmission departure function from the WTRU buffer to a scheduled grant. A traffic flow competing for resources on a given uplink grant may be shaped by an envelope, E. For example, E(t-s)>=A(s,t). A traffic shaper may be a scheduling implementation, which for example may enforce departing UL traffic to comply with a given traffic envelope and/or may buffer non-compliant traffic.

Shaping traffic for a given flow may be for (e.g., an operator) enforcing that traffic from and/or to a given data flow complies with the subscribed data rate. Traffic may be shaped for video streaming over a cellular network, for example as video streaming over the cellular network may utilize (e.g., require) matching a rate of video streams to the available capacity of a radio frequency (RF) link.

The traffic shaping/regulation may be referred to as traffic shaping and/or smoothing. Transmitted traffic may be classified as shaped/compliant traffic and/or non-shaped traffic. Shaped/compliant traffic may be traffic that satisfies a given traffic specification. For example the traffic may be served in the bounds of the traffic departure envelope. Non-shaped traffic may be traffic allocated to a grant and/or traffic that exceeds the traffic shaper (e.g. the water level in traffic shaping bucket). Non-shaped traffic may be considered lower and/or best-effort priority. Non-shaped traffic for example, may be buffered if not transmitted.

A leaky bucket algorithm may be an example of a traffic shaping regulator, for example for a given flow. The leaky bucket algorithm may be described such that a bucket is filled with fluid up to the indicated level, where LB(t) indicates the filling level of the bucket at time t. A leaky bucket may enforce an envelope, for example of the form E(t)=b+r.t, where b is the maximum burst size (e.g., useful for bursty traffic) and r is the long-term traffic rate (e.g. set as the statistical average of the traffic transmission rate requirement). The bucket may be (e.g., initially) set to LB(0)=b, which for example may be referred to as a full bucket. The buffer may be filled with fluid at a rate r, however for example nothing may be added when the bucket is full. The content of the bucket LB(t) may correspond to a maximum amount of traffic that may be transmitted at the time of transport block (TB) construction (e.g., when there is sufficient space). For a (e.g., each) transmission of an service data unit (SDU) for example, the content of the leaky bucket may be reduced by the size of the SDU. When LB(t)=0, the bucket may be empty, and for example no traffic may be transmitted. Traffic arrivals to an empty bucket may be stored in the buffer. Traffic in the buffer may be transmitted at the filling rate r.

The LCP algorithm used for UL TB construction (e.g., in LTE and/or NR may be an example of a leaky bucket implementation. The LCP “Bj” may be (e.g., essentially) a leaky bucket that may enforce that traffic complies to a long-term rate (e.g., PBR) and/or a bucket size (e.g., PBR×BSD). The LCP leaky bucket may enforce an envelope of the form E(s)=b+PBR. S, where for example b is 0 and PBR is the long-term traffic rate (e.g. set as the statistical average of the traffic transmission rate requirement).

Collected data for the training of an AI/ML model may have different requirements and/or characteristics than normal user plane (UP) traffic. For example, a WTRU may be configured to log measurements related to (e.g., some) AI/ML model/functionality. Additionally, or alternatively, the WTRU may have a certain amount of buffer capability to collect such measurements (e.g., related to AI/ML model/functionality). Data may be collected from many WTRUs and/or model training may be done at a training server. It (e.g., therefore) may not be urgent to send collected data on a real time basis. The model may be trained at a function/entity within the operator's network and/or an OTT server that is outside the operator's network (e.g., is owned by the WTRU vendor or a third party, etc.) for example. The data may (e.g., therefore) not have a given/fixed bit rate, priority, and/or latency requirements, for example as for a typical DRB.

If the buffer available for logging (e.g., such) data is full for example, collected data may be sent immediately. For example, the WTRU may (e.g., otherwise) stop/pause the data collection and/or must flush older measurements for newer ones. This may not be desirable for example as an older measurement may not be less valuable. For example measurements may not be intended to be used for real time actions. Some scheduling/rate control mechanisms may be defined to handle the transmission of DRBs/SRBs and/or may not be sufficient/appropriate for sending of data collected for the training of an AI/ML model.

Systems and methods herein may enable dynamic scheduling and/or rate control of mechanisms that may enable transmission of collected data for AI/ML model training, for example optimal transmission of collected data for AI/ML model training. Systems and methods herein may enable transmission of collected data for AI/ML model training without compromising the transmission of (e.g., other) UP/control plane (CP) traffic.

There may be dynamic scheduling of collected data. A WTRU may be configured with a bearer that, for example may be used to send logged/collected data. The WTRU may additionally, or alternatively, be configured with conditions/thresholds for restricting and/or prioritizing the scheduling of the logical channel of the associated bearer. For example the conditions/thresholds may include network conditions such as radio signal level or congestion, WTRU conditions such as current level of buffer occupancy associated with the data collection, the activity/buffer level of other DRBs, and/or the reception of a request to report collected data from network or OTT server, etc. Conditions, events, and/or rules may be associated with each other. For example, conditions, events, and rules may be interchangeable.

A WTRU may receive configuration information. The configuration information may include a data collection configuration (e.g., RRC message). The (e.g., data collection) configuration may include an indication of data to be collected, for example a measurement configuration. The (e.g., data collection) configuration may additionally, or alternatively, include configuration information related to an associated bearer (e.g., DRB, low priority SRB) and/or logical channel to be used for reporting the collected data, a first set of conditions/events to related to the performing data logging/collection (e.g., starting conditions, stopping conditions, logging conditions, etc.), and/or a second set of thresholds/events for modifying the scheduling of the logical channel of the associated bearer (e.g., restriction/prohibition, an increase/decrease in priority, an increase/decrease in PBR, and/or an increase/decrease in BSD, etc.). For example the second set of thresholds/events may include an indication of a volume of collected data, a WTRU battery/power level, a data collection reporting request (e.g., from the network and/or from OTT/application server), a congestion level (e.g., based on indication form the network), an activity/buffer level of (e.g., other bearers), one or more serving cell radio conditions, and/or a recovery from failure (e.g., beam recovery, radio link failure recovery, etc.).

The WTRU may perform the data collection/logging, for example according to the first set of conditions/events. The WTRU may transmit one or more packet data convergence protocol (PDCP) SDUs to a PDCP entity of the associated bearer. The WTRU may receive a UL grant (e.g., dynamic grant, configured grant). The WTRU may update LCP related parameters of the data collection logical channels, for example using the second configuration and/or current conditions. The WTRU may perform the LCP procedure and/or determines the amount of data (e.g., if any) of the data collected to be sent using the UL grant. The WTRU may transmit the UL data, for example using the UL grant.

A WTRU may be configured with one or more UL grants, for example that specify how the grant is to be used for sending collected data. The WTRU may be configured with a bearer that is to be used to send logged/collected data. The WTRU may receive a UL grant and/or an indication/configuration (e.g., along with the grant, separately from the grant, etc.) indicating if the grant is to be used. The indication/configuration may additionally or alternatively indicate how the grant is to be used for sending of collected data, for example if the indication/configuration indicates that the grant is to be used. The UL grant and/or indication/configuration may be received in configuration information.

The WTRU may receive (e.g., first) configuration information, for example including a first data collection configuration (e.g., RRC message). The first data collection configuration may include an indication of the data to be collected (e.g., measurement configuration), configuration information related to an associated bearer (e.g., DRB, low priority SRB) to be used for reporting the collected data, and/or a first set of conditions/events to related to the performing data logging/collection (e.g., starting conditions, stopping conditions, and/or logging conditions, etc.). The WTRU may perform the data collection/logging according to the first set of conditions/events and/or transmit the one or more PDCP SDUs to the PDCP entity of the associated bearer. The WTRU may receive an UL grant (e.g., dynamic grant, configured grant).

The WTRU may receive second configuration information, for example with the UL grant or separately. The second configuration information may indicate whether the grant may be used for sending collected data. For example, the second configuration information may indicate that the grant is not to be used, the grant may only to be used for sending collected data, the grant may be used according to legacy rate control, a maximum percentage of the grant to be used for collected data, collected data prioritized/down prioritized, and/or that the data may be sent as padding if there is space, etc. The WTRU may use the information provided in the second configuration (e.g., the second configuration information) to determine the amount of data from the associated bearer and/or other bearers to be sent using the UL grant (e.g., along with the LCP procedure). The WTRU may transmit the UL data, for example using the UL grant.

Systems and methods may provide consistency between training and inference. A (e.g., given) AI/ML model may be trained under (e.g., certain) WTRU and/or network side conditions. For example, a WTRU side condition may include a speed of the WTRU. Network side conditions may be related to network configurations/settings, for example that the WTRU may not be aware and/or may impact the performance of the model. For example, an RLF prediction model may perform differently if the model was trained when the network was using a certain antenna pattern, beam pattern, and/or power level, etc. There may be aspects related to network load, that for example may impact model performance.

The WTRU may not need and/or have details of the network side conditions. For example, the network may not provide (e.g., some) details. The network may hide these details, for example by signaling to the WTRU one or more associated ID(s). For example, when data is being collected for training a model, tagging may be performed. The tagging may indicate under which network side conditions the model is being trained. Before a WTRU is being configured to perform an operation based on an AI/ML model for example (e.g., measurement prediction), the WTRU may be configured to check the consistency between condition. For example the WTRU may be configured to check the consistency between the conditions under which the AI/ML model is trained and current conditions (e.g., current WTRU conditions, and/or current associated ID(s) signaled by the network indicating current network conditions/settings, etc.).

The term life cycle management (LCM) may be used to describe (e.g., overall) management aspects of AI/ML models. Example management aspects of AI/ML models may include model training, functionality/model identification, model delivery/transfer, model inference operation, functionality/model monitoring, model update, WTRU capability, data collection (for model training, for monitoring, for inference, etc.), and/or functionality/model selection, activation, deactivation, switching, and/or fallback operation. Functionality/model selection, activation, deactivation, switching, and/or fallback operation may include a decision by the network (e.g., either network initiated or WTRU-initiated and requested to the network), and/or a decision by the WTRU (e.g., event-triggered as configured by the network, WTRU's decision reported to the network, and/or WTRU-autonomous either with WTRU's decision reported to the network or without it).

LCM may be functionality-based LCM and/or model-ID based LCM. In functionality-based LCM for example, a network may indicate activation/deactivation/fallback/switching of AI/ML functionality. For example the network may indicate activation/deactivation/fallback/switching of AI/ML functionality via 3GPP signaling (e.g., RRC, MAC-CE, DCI). Models may not be identified at the network in some examples. A WTRU may perform model-level LCM, for example if the models are not identified at the network. The WTRU may have one AI/ML model for a functionality or the WTRU may have multiple AI/ML models for the functionality.

In model-ID-based LCM for example, models may be identified at the network. The network/WTRU may activate/deactivate/select/switch individual AI/ML models, for example via model identifier (ID). In the functionality based LCM for example, the WTRU may choose the AI/ML model to use for a certain functionality. The network may determine for which functionalities the WTRU may use AI/ML based operation. The WTRU may (e.g., then) determine the AI/ML model to use, for example based on the network determination of for which functionalities the WTRU may use AI/ML based operation.

In the model-ID based LCM for example, the network may (e.g., explicitly) control which (e.g., particular) model may be used for a given AI/ML functionality. For example, the WTRU may provide details of AI/ML models and/or capabilities. The network may determine which model to activate for a particular functionality.

Systems and methods herein may be applicable to (e.g., both) model-ID based and/or functionality-based LCM. Systems and methods may be related to how the WTRU may determine whether the WTRU has a model that is applicable for the indicated associated ID(s). For example for functionality-based LCM, the WTRU may be configured/requested to determine if a given functionality is valid/applicable. The WTRU may determine if the (e.g., given) functionality is valid/applicable determination among (e.g., all) the models that the WTRU has. The WTRU may determine that the functionality is applicable, for example if at least one of the models is applicable. For model-ID based LCM for example, the WTRU may be configured/requested by the network to determine whether a particular model is applicable or not. An associated identifier (ID) may be specific to a given functionality and/or the ID may be applicable/common to more than one and/or functionalities.

The WTRU may support several AI/ML models for a given functionality, for example with different prediction time horizons, prediction confidence levels, processing requirements, and/or trained under/for operation in different frequencies/cells/location/times of day, etc. An (e.g., given) AI/ML model for a certain functionality may operate in different modes (e.g., with different levels of prediction confidence levels at different prediction time horizons, at different locations, frequencies, and/or WTRU mobility pattern/speed, etc.). The AI/ML models may be available at the WTRU already trained or the WTRU may be provided with an untrained AI/ML model. The WTRU may train a model, for example an untrained model. In some examples the WTRU may further train a trained model.

The AI/ML model may be available at the WTRU already trained, and the WTRU may be enabled/configured to perform further training (e.g., for different conditions such as frequencies/cells/location/times of day, for the same conditions as the initial training but for increasing the level of confidence or/and the prediction time horizon, and/or for different WTRU speeds, etc.). The AI/ML model may be available at the WTRU but not trained at all or only trained for certain WTRU/network conditions. The WTRU may be configured to train the model (e.g. for the conditions that it is not trained for).

In some examples, the WTRU may utilize some configurations/inputs for performing the inference using an AI/ML model. For example for radio signal level prediction, the WTRU may be configured with a certain number of beams/cells to measure to determine the prediction. In some examples, the WTRU may communicate a requested (e.g., required) configuration/input as part of the capability information. Additionally, or alternatively, the WTRU may communication a requested (e.g., required) configuration/input to the network after a capability request (e.g., based on explicit network request, if the WTRU gets configured to do AI/ML based measurement predictions, and/or the WTRU has determined that it is lacking the required configuration/input, etc.).

A WTRU may be configured to collect data, that for example may be used for training of an AI/ML model. In some examples the WTRU may not be configured to perform AI/ML based operations. The data to be collected may be used for a training a network sided model, a WTRU sided model, or the WTRU and/or network sides of a two-sided model (e.g., a CSI compression model where there is an encoder model at the WTRU and a corresponding decoder model on the network side).

Systems and methods herein may be applicable to (e.g., any kind of) data collection that is performed for other purposes than a training of an AI/ML model, for example sensing and/or application layer performance monitoring. Systems and methods herein may be applicable to data not related to data collection, for example applications that may have similar needs to data collection (e.g., by default having no latency and/or bit rate requirements but with the requirements changing based on some conditions). Systems and methods herein may be applicable to a (e.g., any) data collection architecture, for example regardless of the destination server for the data (e.g., within the RAN, in the CN, within the operator's network outside the RAN/CN, and/or outside the operator's network). The terms functionality and procedure may be used interchangeably. The terms data, measurement(s), report(s), and/or result(s) may be used interchangeably. The terms logging and collecting may be used interchangeably. Other associated terms such as like logged data and collected data, etc. may be used interchangeably. The terms indication, information, and/or message may be used interchangeably.

Systems and methods herein may be summarized in two main categories. The two categories may include a UL grant with a configuration (e.g., configuration information) regarding usage for data collection and dynamic modification of data collection logical channel handling during scheduling.

The UL grant may include a configuration (e.g., configuration information) regarding usage for data collection. For example the WTRU may be configured with an UL grant. The UL grant may be associated with data collection usage. The association with data collection usage may indicate one or more of data collection logical channels may not be scheduled in the grant and/or data collection logical channels may be scheduled in the grant.

Data collection logical channels may not be scheduled in the grant in some examples. The DCI may indicate whether data collection logical channels (LCHs) are applicable to the grant or not (e.g. as a function of a bit indicated in the DCI or the RNTI used to schedule the WTRU). Additionally, or alternatively, the WTRU may determine whether data collection LCHs are applicable to the grant or not based on a property of the grant (e.g. a physical layer characteristic, such as MCS, subcarrier spacing, bandwidth part (BWP), carrier, grant time/frequency domain allocation, etc.).

Data collection logical channels may be scheduled in the grant in some examples. Data collection logical channels may be scheduled in the grant as padding bits after other DRBs/SRBs have been scheduled. Data collection logical channels may be scheduled in the grant after other non-data collection logical channels have been scheduled up to their PBRs (e.g., data collection logical channels not considered during a first portion of a MAC rate control procedure). Data collection logical channels may be scheduled in the grant such that a certain minimum percentage of the grant may be assigned to data collection logical channel(s). Data collection logical channels may be scheduled in the grant such that a certain maximum percentage of the grant assigned to data collection logical channel(s).

There may be dynamic modification of data collection logical channel handling during scheduling. For example, there may be dynamic modification of data collection logical channel handling during scheduling based on one or more (e.g., several) conditions (e.g., collected data volume, volume of data of other DRBs, WTRU battery level, serving cell radio conditions, reception of data collection report request, and/or on some events such are recovery from failure, etc.). The MAC may consider the logical channels associated with data collection logical channels differently (e.g. for a given time duration). For example the WTRU may restrict a logical channel associated with data collection from being scheduled (e.g. inclusion of data from one LCH bars inclusion of data collection LCHs from being multiplexed, and/or visa-versa). The WTRU may modify priority (e.g., prioritize, down prioritize).

Data collection LCHs priorities may be downgraded (e.g. to a configured value) if data from other LCHs is buffered for example. Data collection LCHs priorities may be downgraded in the first round and/or second round of LCP. The WTRU may modify a prioritized bit rate (PBR). Data collection PBRs may be (e.g., temporarily) downgraded (e.g. to a configured value), for example if data from other LCHs is buffered. The WTRU may modify the bucket size duration (BSD). The BSD of data collection LCHs may be increased, for example when a data collection LCH is restricted from being served on a given grant (e.g. due to any of the reasons herein) and/or when priorities/PBRs are downgraded.

The LCP algorithm may include three rounds. The first two rounds may be a described herein, for example with exclusions of data collection LCHs and/or priority downgrades. A third round may be used to allocate data amongst data collection LCHs. The third round may be applicable, for example if space remains in the grant and/or no other LCHs have buffered data for transmission.

There may be a data collection configuration, for example in configuration information. The WTRU may receive the data collection configuration from the network (e.g., gNB, LMF, CN, OAM, NWDAF, and/or any Network Function NF within the operator's network) and/or from outside the network (e.g., OTT server). The WTRU may need to request a measurement configuration from the network, for example to be configured to gather the required information. For example the WTRU may need to request a measurement configuration from the network if the data collection configuration is coming from outside the network.

The WTRU may receive a data collection configuration (e.g., configuration information). The data collection configuration may include one or more of that may include one or more of information/measurement to be logged, (e.g., additional) information the WTRU may include in the measurements (e.g., timestamps, location/cell information, associated IDs, and/or WTRU side conditions, etc.), a logging periodicity, logging events/conditions (e.g., radio conditions that may be fulfilled for the logging to be performed, times of the day for the logging to be performed, and/or areas/cells where the logging is to be performed, etc.), information regarding when logging is to be started (e.g., immediately, after a certain time delay, at an absolute time in the future, when WTRU goes into certain area/cell, etc.), information regarding when logging is to be stopped/paused (e.g., when the amount of collected data reaches a certain buffer threshold, when a certain number of samples have been collected, etc.), information regarding when collected data may or may not be reported to the network (e.g., specific time window during which collected data may be sent or may not be sent, and/or may be done dynamically via an explicit indication to start/stop sending the collected data, as discussed herein), and/or information related to the data destination (e.g., RAN, CN, OAM, another NF, OTT server, etc.), etc.

A data collection configuration may be referred to as a data collection process herein. The data collection configuration may be related to a certain higher usage level (e.g., sensing, AI/ML operation, etc.) and/or may be at a detailed granularity level for example different data collection configurations for the training of models for different AI/ML functionalities and/or sub functionalities (e.g., one for CSI compression, one for temporal beam/cell measurement prediction, one for spatial beam/cell measurement prediction, and/or one for positioning, etc.). The data collection configuration may be included in configuration information.

Multiple data collection configurations may be provided to the WTRU separately. A (e.g., each) data configuration may configure different measurements/information to be gathered and/or may have different detailed information/parameters regarding the given data collection configuration. Additionally, or alternatively, all or a subset of the configuration may share some of the configuration elements (e.g., may have a common periodicity, similar additional information to add to the measurements, and/or stopping/reporting conditions, etc.) and/or may have separate configuration elements (e.g., the measurement to be performed, events for logging, and/or buffer level thresholds, etc.).

There may be an association of data collection bearers and logical channels. The WTRU may receive a configuration regarding how the collected data based on the received configuration is to be mapped to an associated bearer and logical channel. The associated bearer may be referred to as data collection bearer herein. The associated logical channel may be referred to as data collection logical channel herein.

The mapping may be according to one or more of one data collection bearer/logical channel for all data collection configurations, separate data collection bearer/logical channel for each data collection configuration, separate data collection bearer/logical channel for different types of data collection (e.g., one for data collection for AI/ML model training, and/or one for data collection for sensing, etc.), separate data collection bearers/logical channels for different data termination points/destinations (e.g., one for data destined at a RAN entity/network function, one for data destined at CN entity/network function, one for data to be collected at the OAM, and/or one for data to be collected at an OTT server outside the operator's network, etc.), and/or multiple bearers/logical channels. Additionally, or alternatively, bearers may be mapped according to the need/requirements of the collected data. For example, higher priority/quality collected data based on different data collection configurations may be sent via one bearer/logical channel and/or low priority collected data may be sent based on a different data collection configuration.

A data collection configuration(s) may be mapped to a data radio bearer (DRB) and/or a signaling radio bearer (SRB). The terms data collection bearer, collected data bearer, data collection logical channel, and/or logical channel for data collection may be used interchangeably herein. There may be configuration related to enhanced UL grant and/or LCP operation. Systems and methods herein may enhance the UL grant configuration/allocation and/or LCP procedure, for example based on (e.g., considering) the need/requirements of collected data. Different parameters/thresholds/settings may be for controlling these mechanisms. For example, buffer thresholds may be associated with one or more of the data collection processes/configurations, and/or timing aspects, etc. The WTRU may (e.g., therefore) receive associated configurations, for example that set the parameters/thresholds that may be used to control the different UL grant and/or LCP enhancements (e.g., as discussed herein). The configurations may be separate for each data collection configuration, common for all data collection configurations, and/or a subset of the data collection configurations may share the parameter/threshold configurations.

Example parameters/thresholds may include a volume of collected data, a WTRU battery/power level, one or more timing related thresholds (e.g., remaining or elapsed time since data collection has started or since the first pending data is logged, and/or time since the data collection report request has been received, etc.), a network congestion level, an activity level/buffer level of non-data collection bearers/logical channels, one or more serving cell radio conditions, and/or an occurrence of one or more events (e.g., recovery from RLF, re-establishment, mobility, and/or beam failure, etc.). The (e.g., different) parameters/thresholds may be mapped to a (e.g., different) priority/PBR/BSD level and/or a function/logic of how a change in a (e.g., particular) parameter value may be translated into a change in priority/PBR/BSD, etc.

There may be generalization to (e.g., other) protocol stacks/architectures. Systems and methods herein may utilize a NR protocol architecture for single connectivity, for example with no duplication or split bearer operation. For example, for each bearer there may be one PDCP entity, one RLC entity, and/or one logical channel. A WTRU may have a single MAC entity. However, systems and methods herein may additionally, or alternatively, utilize other protocol architectures and/or bearer to logical mappings (e.g., in 6G). For example, systems and methods may be utilized for a bearer-less operation (e.g., each packet containing header information that may be used by the MAC for LCP operation), a many-to-many mapping between bearers and logical channels (e.g., one bearer mapped to multiple logical channels even though there is no legacy split bearer or duplication being performed, and/or one logical channel mapped to multiple bearers, etc.), a UP protocol stack that may not include the RLC (e.g., PDCP sitting directly above MAC), and/or a separate data plane protocol stack (e.g., that may have its own logical MAC entity). For example (e.g., all) the logical channels for data collection may be associated with the separate data plane protocol stack.

Systems and methods herein may be applicable to cases and/or architectures/protocol stacks, for example as discussed herein. For a separate data plane protocol stack for example, an application of the UL grants enhancements may include conditions being fulfilled for enabling an UL grant to be used for sending collected data (e.g. a certain percentage of it). A new logical MAC entity that may be associated with the data plane may (e.g., then) be assigned the determined portion/percentage of the UL grant and/or may perform an LCP procedure among the data collection logical channels that it is serving. Another (e.g., MAC) entity may perform the LCP for the non-data collection logical channels on the remaining UL resources for example.

There may be separate UP and data plane (DP) LCPs. A DP MAC entity may determine (e.g., assume) that a grant size is a size communicated from a UP MAC entity (e.g., cross-stack indication). The UP MAC entity may (e.g., first) allocate data to the grant using the LCP procedure. The remaining bits in the grant (e.g. that would have been padding bits) may (e.g., then) be communicated to the DP MAC entity and/or be the grant size available for transmission by the DP MAC entity.

The UP-MAC entity may be configured with data dependency LCP restrictions, for example where a given UP logical channel (LCH) may or may not be applicable (e.g. restricted). The given UP LCH may or may not be applicable based on whether there is DP data to be included on the same grant, and/or visa-versa. For example, the WTRU may omit the inclusion of SRB or system data in the grant if data collection data is to be included as well.

The DP-MAC entity may be configured with data dependency LCP restrictions, for example where the DP LCH may be restricted if UP LCH (e.g. of priority>a threshold or from a set of configured LCHs) is included and/or may be included in the grant. The DP LCH may be restricted for example, if it reduced the reliability of the overall grant (e.g. assuming UP data is included).

There may be a multi-decodable parts grant. The WTRU may receive a grant with separately decodable parts. The separately decodable parts may include a part for UP data, a part for control elements, a part for headers, and/or a part for DP data. A (e.g., each) grant part may have its own CRC check and/or may be retransmitted separately. The WTRU MAC entity may operate on a given grant part. The DP MAC entity may additionally, or alternatively, run LCP on a grant part, for example a different grant part. The WTRU may determine a size associated with a (e.g., each) part and/or run LCP (e.g., separately) for a (e.g., each) part.

A given grant part (e.g. the DP grant part) may be conditionally used, for example based on a WTRU measured channel condition (e.g., RSRP, RSRQ, SINR, and/or power headroom) being above or below a threshold. For a grant part that is not used for example, the WTRU may refrain and/or drop multiplexing data from the LCHs applicable for the grant part. A (e.g., each) grant part type (e.g., DP and/or UP) may be configured with a set of applicable LCHs. A LCH may (e.g., therefore) be conditionally multiplexed, for example depending on whether the applicable grant part is used. If a grant part is not used for example, the WTRU may use a subset of the physical layer resources associated with the grant (e.g. a subset of DRBs). The WTRU may indicate (e.g. in a MAC CE and/or a UCI) the used parts, which may for example improve the reliability and/or PSD (e.g., if the WTRU is in bad coverage).

There may be aspects related to UL grant enhancements. UL grants for scheduling data collection logical channels may be enabled and/or disabled. The WTRU may be configured to be in an on/off state for scheduling data collection logical channels on an UL grant. For example, the WTRU may receive an indication to disable the scheduling of data collection logical channels. The WTRU may be configured to be in an on/off state for scheduling data collection logical channels at one or more levels of granularity, for example on an UL grant for all logical channels associated with collected data, a certain subset of logical channels associated with collected data, and/or individual data collection logical channel(s). The certain subset of logical channels associated with collected data may be associated with certain application (e.g., sensing, AI/ML, etc.), associated with a given AI/ML functionality (e.g., beam management, positioning, etc.), and/or associated with a given destination (e.g., data collected at RAN, CN, OAM, OTT, etc.), etc.

The granularity at a subset of the logical channels may be implicit or explicit. For example, as herein, the mapping between the data collection bearers and applications, AI/ML functionalities, and/or data collection server location, etc. may be performed at a higher layer (e.g., SDAP, PDCP, RRC, etc.) and/or MAC may not be aware of this association. The granularity may (e.g., therefore) be indicated to the MAC at a logical channel and/or logical channel group level. In some examples, the MAC may be configured to become aware of the logical channels or logical channel groups associated with data collection. The MAC may (e.g., therefore) know which logical channels or logical channel groups should not be scheduled, for example based on a received indication to disable UL grants for data collection.

The WTRU may prohibit the use of UL grants for scheduling data of a concerned bearer(s)/logical channel(s), for example upon receipt of the message to disable the UL scheduling of one or more data collection bearer(s)/logical channels. Additionally, or alternatively, the WTRU may prohibit the use of UL grants for scheduling data of the concerned bearer(s)/logical channels until one or more conditions are fulfilled. Example conditions may include a subsequent message being received that enables their scheduling, a certain configured time duration elapsing (e.g., specified in absolute time values, frames, slots, and/or if it is related to configured grants for example for how many grant instances in the future, etc.) after the reception of the message, a certain configured amount of UP data that is not related to collected data has been transmitted (e.g., in terms of packets, and/or actual number of bits, etc.) since the reception of the disabling message, a certain configured amount of data of collected bearers that were not disabled from scheduling have been transmitted (e.g., in terms of packets, and/or actual number of bits, etc.) since the reception of the disabling message, and/or the (e.g., pending) data volume of the concerned data collection logical channel(s) exceeds a certain level (e.g., absolute values, and/or relative values as compared to the maximum buffer level and/or the buffer level when the disabling message was received, etc.), etc.

The WTRU may (e.g., autonomously) enable the scheduling of the data collection bearers/logical channels, for example when the one or more conditions are satisfied (e.g., fulfilled). The WTRU may additionally, or alternatively, receive an explicit indication to enable the scheduling of data collection logical channels. The explicit indication to enable the scheduling of data collection logical channels may be at different levels of granularity, for example as discussed herein.

The WTRU may use the UL grants for scheduling data of the concerned bearer(s)/logical channels (e.g., following the legacy LCP procedure), for example upon the reception of the message to enable the UL scheduling of one or more data collection bearer(s)/logical channels. The WTRU may use the UL grants for scheduling data of the concerned bearer(s)/logical channels, for example until one or more conditions are fulfilled. Example conditions may include a subsequent message being received that disables their scheduling, a certain configured time, duration elapsing (e.g., specified in absolute time values, frames, slots, etc., and/or if it is related to configured grants for example for how many grant instances in the future, etc.) after the reception of the message, a certain configured amount of data of UP traffic not related to data collection has not been transmitted (e.g., in terms of packets, and/or actual number of bits, etc.) within a given configured time duration since the reception of the enabling message, a certain configured amount of data of the concerned bearers that were recently enabled for scheduling has been transmitted (e.g., in terms of packets, and/or actual number of bits, etc.) since the reception of the enabling message, a certain configured amount of data of all data collection logical channels has been transmitted (e.g., in terms of packets, and/or actual number of bits, etc.) since the reception of the enabling message, and/or the (e.g., pending) data volume of the concerned data collection logical channel(s) falls below a certain level (e.g., absolute values, and/or relative values as compared to the maximum buffer level or the buffer level when the disabling message was received, etc.), etc.

The message to enable/disable the scheduling of data collection logical channels may be an RRC message, for example a dedicated RRC message, and/or a broadcast message, etc. Additionally, or alternatively, the message to enable/disable the scheduling of data collection logical channels may be a MAC CE and/or a DCI.

The WTRU may be pre-configured on a timetable for when the scheduling is enabled and/or disabled, for example in addition or alternatively to enabling/disabling the scheduling of data collection logical channels via explicit signaling. For example scheduling may be enabled for a certain data collection channel, a subset of the logical channels, or all the data collection logical channels (e.g., only) between t1 and t2, where t1 and t2 may be absolute times.

The semi-static configuration for enabling/disabling the data collection may be based on areas/cells. For example a WTRU may be pre-configured to enable/disable the scheduling of data collection logical channel(s) in certain cells, and/or PLMNs, etc. The semi-static configuration may be included in configuration information.

The message to enable/disable the scheduling of data collection logical channels may include an indication of one or more parameters, for example as discussed herein. Example parameters may include the amount of time, data volumes, and/or the affected data collection bearer(s)/logical channel(s), etc., for example for controlling how long the disabling/enabling is valid. Additionally, or alternatively, the WTRU may be pre-configured with one or more parameters (e.g., values) separately from the enabling/disabling message (e.g., in previous messages, e.g., MAC/LCH/bearer configurations, and/or values indicated in 3GPP standards, etc.).

The WTRU may be configured to apply the enabling/disabling of UL grants behavior, for example as described herein, to dynamic grants, configured grants (e.g., type 1 and/or type2), or both dynamic and configured grants. For example, the enabling/disabling messages may indicate the association for configured and/or dynamic grants. In some examples, the WTRU may be configured separately (e.g., in an earlier configuration) whether the enabling/disabling is concerning configured grants (e.g., type 1, type2 or both) and/or dynamic grants. In some examples, when a type 2 grant is activated, there may be an indication in the activation message which indicates if data collection logical channels may be enabled/disabled for scheduling on that configured grant.

There may be UL grants which have an associated configuration for handling collected data. The (e.g., associated) configuration may be included in configuration information. The WTRU may be configured with information regarding the usage of an UL grant (e.g., configured grant and/or dynamic grant), for example for sending data from a data collection bearer/logical channel. The WTRU may be configured with a (e.g., new kind of) configured grant (e.g., type 3). The (e.g., type 3) configured grant may be activated upon reception of the configuration (e.g., as in type 1). The type 3 grant may be (e.g., only) used for scheduling data collection logical channels for example.

The WTRU may be configured with a (e.g., new kind of) configured grant (e.g., type 4). The (e.g., type 4) configured grant may need further activation after configuration (e.g., as in type 2). The type 4 grant may be (e.g., only) used for scheduling data collection logical channels for example.

There may be an indication in an UL grant (e.g., dynamic grant and/or configured grant), for example indicating whether that grant is to be used for scheduling data collection logical channels. The indication may be at different levels of granularity and/or restriction limits. For example the indication may indicate that the grant may not be used for any data collection logical channels, the grant may be used (e.g., only) for data collection logical channels (e.g., if there is more space left after scheduling data collection channels, and/or other data may be scheduled), the grant may be used for a subset of logical channels that are associated with collected data, the grant may be used for data collection (e.g., only) as a padding (e.g., if there is room in the grant after scheduling all other UP/CP traffic, and/or any data collection logical channels that were not excluded from the grant as above), the grant may be used for data collection (e.g., only) after other non-data collection logical channels have been scheduled up to their PBRs (e.g., data collection logical channels not considered during a first portion of the MAC rate control procedure), a certain minimum percentage of the grant assigned to data collection logical channel(s), a certain maximum percentage of the grant assigned to data collection logical channel(s), and/or that the grant may be used for data collection if the volume of collected data is above a certain threshold (e.g., absolute threshold, and/or relative threshold compared to the maximum buffer level for the data collection logical channel(s)), etc.

The indication that the grant may be used for a subset of logical channels that are associated with collected data may be associated with certain application (e.g., sensing, and/or AI/ML, etc.), associated with a given AI/ML functionality (e.g., beam management, and/or positioning, etc.), and/or associated with a given destination (e.g., data collected at RAN, CN, OAM, and/or OTT, etc.), etc.

The WTRU may be configured with a configured grant of a certain periodicity. Additionally, or alternatively, there may be a second periodicity/pattern associated with the grant, for example where the WTRU will apply a behavior (e.g., as herein) when (e.g., only when) aligned with the second periodicity/pattern. For example, an UL grant may be configured with a periodicity of every n slots. A second periodicity may be configured as every 3n slots, for example such that the WTRU may apply one behavior every third configured grant instance (e.g., 1^{st} grant instance: no collected data scheduled, 2^{nd} grant instance: no collected data scheduled, and/or 3^{rd} grant instance: a certain minimum percentage of the grant may be assigned to collected data if data is available, etc.)

The WTRU may use the UL grants for scheduling data of the concerned bearer(s)/logical channels (e.g., following the legacy LCP procedure), for example if the WTRU receives DL signaling allowing the multiplexing of the LCHs and/or the associated data type. DL signaling may include an explicit flag and/or an RNTI. The WTRU may determine whether the data collection LCH is applicable as function of a HARQ process ID signaled for the grant, for example when the WTRU may be configured with an association between HARQ PID/DL indication and a data type or bearer type (e.g. UP LCHs only, UP and DP LCHs, and/or DP LCHs only, etc.).

Aspects related to LCP procedure are disclosed herein. Systems and methods may utilize conditional modification of priority of data collection logical channels. The WTRU may be configured to modify the priority level of a data collection logical channel, for example depending on the volume of the collected data that is pending to be sent. In some examples a logical channel may have priority values from 1 to 16, where 1 may be the highest priority level and 16 may be the lowest priority level. Raising the priority level as herein may refer to decreasing the priority value. Lowering the priority level as herein may refer to increasing the priority value. If higher priority values are associated with higher priority levels in a system for example, raising the priority level as herein may refer to increasing the priority value and/or lowering the priority level as herein may refer to decreasing the priority value.

In some examples a data collection logical channel may have a default/initial priority (e.g., low priority level). The WTRU may be configured to modify the priority according to one or more rules. Example rules may include if the volume of collected data pending to be transmitted exceeds a certain threshold (e.g., absolute threshold, and/or a percentage of the maximum buffer allocated for the data collection, etc.), the WTRU may increase the priority (e.g., set to a higher configured absolute priority level, and/or the priority level raised by a configured delta level over the default or the current priority level, etc.) , and/or if the volume of collected data pending to be transmitted becomes lower than a certain threshold (e.g., absolute threshold, a percentage of the maximum buffer allocated for the data collection, and/or a percentage of the buffer level when the priority was increased previously, etc.), the WTRU may decrease the priority (e.g., set back to the default or previous priority level, and/or the priority level lowered by a configured delta level from the current priority level, etc.).

Different threshold levels may be configured, for example for a step wise approach of raising/lowering the priority level. For example, if a priority level is raised to a next higher level and/or if the buffer level has not decreased below a certain absolute/relative threshold after a certain configured duration, the priority level may be raised to the next higher level (e.g., and so on). If for example the buffer level threshold falls below a certain threshold, the priority may be lowered to the next lower level. This process may continue until a default priority level is reached.

Additionally, or alternatively, raising/lowering of the priority level may be performed in multiple steps at once, for example depending on how much the data volume level has changed within a given time. For example if the data volume has decreased by x %, the priority level may be lowered by one step If the data volume has decreased by 2*x %, the priority level may be lowered by two steps, etc.

An absolute lowest priority level may be defined. For example an absolute lowest priority level may include a priority value 0, a priority value of infinity, a priority value one value higher than the maximum value that any non data collection logical may be assigned to (e.g. 17), for example depending if the higher priority value is associated with a higher priority level or vice versa, as described herein. A data collection logical channel may have the absolute lowest priority level assigned to it by default. When the priority level of a data collection logical channel is at the absolute lowest priority level for example, (e.g., then) the bearer may not be considered for scheduling. In another example the data collection logical channel may be scheduled (e.g., only) if there is a grant, if there is no other data to be transmitted at that time (e.g., other UP or SRB data), and/or if there is some available space in the grant after the other data is scheduled.

The increase/decrease of the priority level may be associated with a validity/expiry time. For example the priority may be reverted to the previous/default value after the configured validity time duration has elapsed. The same or different validity time durations may be configured for increasing and/or decreasing the priority level. If a multiple level increase/decrease are allowed for example, there may be different timer durations associated with the length of the step increase/decrease. For example if the priority has increased by 1 step, (e.g., then) the validity time duration may be set to t1. If for example the priority has increased by 2 steps, (e.g., then) the validity time duration may be set to t2, e.g., t2=t1/2, etc.)

The validity/expiry time may be in absolute time (e.g., ms, slots, frames, etc.) or may be in the number of grants. For example the validity/expiry time may be configured to be equal to n, where n may be the next n UL grants where the newly assigned priority level is valid. The validity/expiry time may be combined with the buffer level thresholds. For example the validity/expiry time and the buffer level thresholds may be fulfilled to trigger the raising/lowering of the priority. The WTRU may be configured with the maximum and/or minimum priority levels/values, that for example may be assigned to the data collection logical channels and/or the (e.g., different) increase/decrease of the priority (e.g., at one time).

In addition to or alternatively to buffer levels as discussed herein, other parameters may be considered in the dynamic modification of the priority of a data collection logical channel(s). Example other parameters may include a WTRU battery/power level threshold, a time remaining and/or an elapsed time related threshold, a time since the data collection report request has been received at the WTRU and/or an elapsed time related threshold, a congestion level, an activity level/buffer level of (e.g., other) DRBs, one or more serving cell radio conditions, occurrence of one or more events, and/or inclusion of (e.g., other) data types and/or data from (e.g., other) LCH types.

A parameter may include a WTRU battery/power level threshold(s). For example, different priority levels for the data collection logical channel(s) may be based on WTRU battery level (e.g., a lower priority associated with low WTRU battery level, higher priority associated with higher power level, and/or absolute lowest priority level if WTRU battery level is below a certain level, etc.). The WTRU may restrict data collection LCHs from multiplexing, for example if the WTRU and/or the network is in a power saving state.

A parameter may include a time remaining and/or elapsed time related thresholds. The time remaining and/or elapsed time related thresholds may be related to an amount of time since data collection started, a time since the earliest collected data sample that is pending to be transmitted, and/or a relative/absolute time difference from a specified deadline (e.g., provided as part of the data collection configuration), etc. For example, a WTRU may be configured to assign the logical channel to the lowest priority and/or an absolute lowest priority. If the remaining time from a pre-configured deadline to send the collected data is above a certain threshold for example, the WTRU may be configured to scale the priority level up (e.g., in a step wise fashion similar to the case for data collection volume level) For example, WTRU may be configured to scale the priority level up the closer to the deadline, the longer the time has elapsed since the data collection has started, and/or the longer the time since the oldest pending collected data has been logged, etc.

A parameter may include a time since the data collection report request has been received at the WTRU and/or elapsed time related thresholds. A WTRU may be configured to assign the logical channel to a higher priority, for example for a certain duration after the reception of the data collection request. The WTRU may be configured to decrease the priority after the time duration has elapsed. The WTRU may be configured to utilize a step wise approach (e.g., similar to data collection volume level discussed herein). For example the WTRU may lower priority one level at a time, for some configured time duration time in between the levels, until the priority reaches the default/initial level, and/or until the priority is set to the absolute lowest value once a certain configured time has elapsed since the reception of the data collection report request.

A parameter may include a congestion level, for example indicated from the network. The WTRU may be configured to decrease/increase the priority level of a data collection logical channel and/or restrict them from multiplexing, for example when the congestion level increases/decreases. For example a priority may be set to level A when no congestion is indicated by the network. Priority maybe reduced to level B, for example if a first level of congestion is indicated by the network. Priority may be reduced to an absolute lowest level, for example if a congestion level indicated by the network is greater or equal to a second congestion level.

A parameter may include an activity level/buffer level of (e.g., other) DRBs. The WTRU may be configured to decrease/increase the priority level of a data collection logical channel and/or restrict them from multiplexing, for example when the buffer/activity level of other non-data collection related bearers increases/decreases. For example a priority may be set to level A when the buffer/activity level of one or more of the non-data collection logical channels is below a first buffer level threshold. A priority maybe reduced to level B, for example if the buffer/activity levels of the other bearers exceeds the first buffer level threshold but lower than a second buffer level threshold. A priority may be reduced to an absolute lowest level, for example if the buffer/activity level of the non-data collection logical channels exceeds the second buffer level threshold.

A parameter may include one or more serving cell radio conditions. The WTRU may be configured to decrease/increase the priority level of a data collection logical channel and/or restrict them from multiplexing, for example when the serving cell radio signal level (e.g., RSRP) decreases/increases. A priority may be set to level A when the serving cell signal level is above a first RSRP threshold. A priority may be reduced to level B, for example if the serving cell signal level is below the first RSRP threshold but greater than a second RSRP threshold. A priority may be reduced to an absolute lowest level, for example if the serving signal level falls below the second RSRP threshold.

A parameter may include one or more occurrence of events. Example events may include recovery from radio link failure (RLF), re-establishment, mobility, detection of radio link problem, recovery from radio link problem, detection of radio link failure, recovery from RLF via re-establishment, recovery from RLF via CHO/LTM, and/or beam failure, etc. The WTRU may be configured to increase/decrease the priority level of a data collection logical channel (e.g., for a certain time duration), for example after the occurrence of an event.

A parameter may include an inclusion of (e.g., other) data types and/or data from (e.g., other) LCH types. A WTRU may downgrade data collection LCH priority and/or PBR (e.g. to a configured value, non-default value or the next lower value from the set of configured values), for example if data from other LCHs is buffered (e.g., in the first round and/or second round of LCP). The WTRU may (e.g., temporarily) use an alternative PBR (e.g., only) for this grant (e.g., that may include other data), for example to determine the Bj level (e.g., dynamic bucket size). The WTRU may (e.g., then) go back to the default PBR for another/next grant (e.g. one that does not contain other data types of no inter-data type dependencies). If the WTRU has downgraded and/or changed the priority and/or PBR for a given data collection data channel for example, the WTRU may start a timer. The WTRU may refer to the default value, for example upon the expiry of the timer. If the WTRU has downgraded and/or changed the priority for a given data collection data channel for example, the WTRU may apply the updated priority (e.g., only) for a subset of LCP steps (e.g. round 1, round 2, and/or round 3 of LCP).

There may be conditional modification of the PBR data collection logical channels. A logical channel may be configured to have PBR values between 0 kilobytes/sec to 65 Mbytes. In some examples the logical channel may be configured to have PBR values of infinity, which for example may be used to assign the logical channel a value like SRB1 absolute highest prioritization in the LCP procedure (e.g., no other data will be scheduled until all the data from such a bearer gets scheduled).

The WTRU may be configured to modify the PBR of a data collection logical channel, for example depending on the volume of the collected data that is pending to be sent. A data collection logical channel may be initially configured with a default/initial PBR of 0 kilobytes/sec and/or a default/initial low priority level or an absolute lowest priority level, for example if an intention is to disable the scheduling of the data collection logical channel as long as there is any other data to be sent. The WTRU may be configured to modify the priority based on one or more (e.g., several) conditions.

The WTRU may be configured to modify the PBR according to one or more rules. The WTRU may be configured to modify the PBR if the volume of collected data pending to be transmitted exceeds a certain threshold (e.g., absolute threshold, a percentage of the maximum buffer allocated for the data collection, etc.). For example if the volume of collected data pending to be transmitted exceeds a certain threshold, the WTRU may increase the PBR. For example the WTRU may set the PBR to a higher configured PBR level, raise the PBR level by a configured delta level over the default or the current priority level, and/or raise the PBR to the next higher PBR value.

The WTRU may be configured to modify the PBR, for example if the volume of collected data pending to be transmitted becomes lower than a certain threshold (e.g., absolute threshold, a percentage of the maximum buffer allocated for the data collection, and/or a percentage of the buffer level when the PBR was increased previously, etc.). If the volume of collected data pending to be transmitted becomes lower than a certain threshold for example, the WTRU may decrease the PBR. For example the WTRU may set the PBR back to the default and/or previous level, lower the PBR by a configured delta level from the current PBR level, and/or set the PBR to the next lowest PBR value.

The WTRU may use a non-default PBR (e.g., only) for the purpose of updating Bj for a given grant, for example if a condition is met to use a non-default PBR. The WTRU may (e.g., then) revert to using the default PBR.

The WTRU may receive DL signalling (e.g. in the scheduling DCI) indicating one or more non-default shaping parameters (including BSD, PBR, and/or Bj), for example to use for the given grant and/or for data collection LCHs.

The WTRU may receive DL signalling indicating to flush the WTRU bucket level that has been accumulated for given LCH. The WTRU may (e.g., then) reset Bj to zero, for example upon reception of the indication.

The WTRU may receive DL signaling indicating to use a non-default/upgraded/or downgraded PBR and/or priority for a given LCH (e.g. for a data collection type). The WTRU may (e.g., upon the reception of the signalling) start a timer. For example, the WTRU may use the non-default/upgraded/or downgraded PBR, BSD and/or priority for the given LCH while the timer is running. The value of the timer may be configured. Upon the expiry of the timer for example, the WTRU may revert to the default PBR, BSD and/or priority.

Different threshold levels may be configured for a step wise approach of raising/lowering the PBR. For example, the PBR may be raised to the next higher level. If the buffer level of the logical channel has (e.g., then) not decreased below a certain absolute/relative threshold after a certain configured duration for example, the PBR may raised to the next higher level (e.g., and so on). If the buffer level threshold falls below a certain threshold for example, the PBR may be lowered to the next lower level. This process may continue until the default/initial PBR level is reached.

Raising/lowering of the PBR may include multiple steps at once, for example depending on how much the data volume level has changed within a given time. For example if the data volume has decreased by x %, the PBR may be lowered by one step. If the PBR has decreased by 2*x % for example, the PBR may be lowered by two steps.

The increase/decrease of the PBR may be associated with a validity/expiry time. For example the PBR may be reverted to the previous/default value after the configured validity time duration has elapsed. The same or different validity time durations may be configured for increasing and/or decreasing the PBR. If multiple level increase/decrease are allowed for example, there may be different timer durations associated with the length of the step increase/decrease. For example if the PBR has increased by one step (e.g., from 8 to 16 kBps), the validity time duration may (e.g., then) be set to t1. If the priority has increased by two steps (e.g., from 8 to 32 kBps) for example, the validity time duration may (e.g., then) be set to t2 (e.g., t2=t1/2, etc.).

The validity/expiry time may be in absolute time (e.g., ms, slots, frames, etc.) or may be in the number of grants. For example the validity time may be configured to be equal to n, where n is the next n UL grants where the newly assigned PBR is valid. The PBR increase/decrease may be set to last only one scheduling session in some examples. The validity/expiry time may be combined with the buffer level thresholds, for example such that both may be fulfilled to trigger the raising/lowering of the PBR. In some examples the fulfillment of either the validity/expiry time or the buffer level thresholds may trigger the raising/lowering of the PBR. The WTRU may be configured with the maximum and/or minimum PBRs, that for example may be assigned to the data collection logical channels and/or the different increase/decrease of the PBRs possible (e.g., at one time).

In addition to or alternatively to buffer levels as discussed herein, other parameters may be considered in the dynamic modification of the PBR of a data collection logical channel(s). Example other parameters may include a WTRU battery/power level threshold, a time remaining and/or an elapsed time related threshold, a time since the data collection report request has been received at the WTRU and/or an elapsed time related threshold, a congestion level, an activity level/buffer level of (e.g., other) DRBs, one or more serving cell radio conditions, and/or occurrence of one or more events.

A parameter may include a WTRU battery/power level threshold(s). For example, different PRBs for the data collection logical channel(s) may be based on WTRU battery level (e.g., a lower PRB associated with low WTRU battery level, higher PRB associated with higher power level, and/or PBR set to 0 kBps if WTRU battery level is below a certain level, etc.).

A parameter may include a time remaining and/or elapsed time related thresholds. The time remaining and/or elapsed time related thresholds may be related to an amount of time since data collection started, a time since the earliest collected data sample that is pending to be transmitted, and/or a relative/absolute time difference from a specified deadline (e.g., provided as part of the data collection configuration), etc. For example, a WTRU may be configured to assign the PBR of the logical to 0 if the remaining time from a pre-configured deadline to send the collected data is above a certain threshold. Additionally, or alternatively the WTRU may be configured to scale up the PBR (e.g., in a step wise fashion, similar to data collection volume level as herein) the closer to the deadline, the longer the time has elapsed since the data collection has started, and/or the longer the time has elapsed since the oldest pending collected data has been logged.

A parameter may include a time since the data collection report request has been received at the WTRU and/or elapsed time related thresholds. A WTRU may be configured to assign the logical channel with a higher PRB, for example for a certain duration after the reception of the data collection request. The WTRU may be configured to decrease the PRB after the time duration has elapsed. The WTRU may be configured to utilize a step wise approach (e.g., similar to data collection volume level discussed herein). For example the WTRU may lower PRB one level at a time, for some configured time duration time in between the levels, until the PRB reaches the default/initial level and/or 0 kBps.

A parameter may include a congestion level, for example indicated from the network. The WTRU may be configured to decrease/increase the PBR of a data collection logical channel when the congestion level increases/decrease. For example PBR may be set to A when no congestion is indicated by the network. PRB may be set to B, for example if a first level of congestion is indicated by the network. PRB may be reduced to 0, for example if congestion level indicated by the network is greater or equal to a second congestion level.

A parameter may include an activity level/buffer level of other DRBs. The WTRU may be configured to decrease/increase the PBR of a data collection logical channel, for example when the buffer/activity level of other non-data collection related bearers increases/decreases. PBR may be set to A when the buffer/activity level of one or more of the non-data collection logical channels is below a first buffer level threshold. PBR may be reduced to B, for example if the buffer/activity levels of the other bearers exceeds the first buffer level threshold but is lower than a second buffer level threshold. The PBR may be set to 0, for example if the buffer/activity level of the non-data collection logical channels exceeds the second buffer level threshold.

A parameter may include one or more serving cell radio conditions. The WTRU may be configured to decrease/increase the PBR of a data collection logical channel, for example when the serving cell radio signal level (e.g., RSRP) decreases/increases. PBR may be set to A, for example when the serving cell signal level is above a first RSRP threshold. PBR may be reduced to B, for example if the serving cell signal level is below the first RSRP threshold but greater than a second RSRP threshold. PBR may be set to 0, for example if the serving signal level falls below the second RSRP threshold.

A parameter may include occurrence of one or more events. Example events may include recovery from radio link failure (RLF), re-establishment, mobility, detection of radio link problem, recovery from radio link problem, detection of radio link failure, recovery from RLF via re-establishment, recovery from RLF via CHO/LTM, and/or beam failure, etc. The WTRU may be configured to increase/decrease the PBR of a data collection logical channel (e.g., for a certain time duration), for example after the occurrence of an event.

There may be conditional modification of the BSD data collection logical channels. A logical channel may be configured to have BSD values of 5 ms, 10 ms, 20 ms, 50 ms,100 ms, 150 ms, 300 ms, 500 ms, and/or 1000 ms in some examples. The WTRU may be configured to modify the BSD and/or Bj level of a data collection logical channel, for example depending on the volume of the collected data that is pending to be sent.

The WTRU may be configured to modify the bucket shaping parameters (e.g. BSD and/or Bj), for example according to one or more rules. The WTRU may be configured to modify the bucket shaping parameters if the volume of collected data pending to be transmitted exceeds a certain threshold (e.g., absolute threshold, and/or a percentage of the maximum buffer allocated for the data collection, etc.). For example if the volume of collected data pending to be transmitted exceeds a certain threshold, the WTRU may increase the BSD and/or Bj. For example the WTRU may set to a higher configured PBR level, raise the PBR level by a configured delta level over the default or the current priority level, and/or raise the PBR to the next higher PBR value.

The WTRU may be configured to modify the bucket shaping parameters if the volume of collected data pending to be transmitted becomes lower than a certain threshold (e.g., absolute threshold, a percentage of the maximum buffer allocated for the data collection, and/or a percentage of the buffer level when the PBR was increased previously, etc.). The WTRU may decrease the BSD and/or Bj by setting the BSD and/or Bj back to the default or previous level, the PBR may be lowered by a configured delta level from the current PBR level, and/or the PBR may be set to the next lowest PBR value. The WTRU may decrease the BSD and/or Bj by setting the BSD and/or Bj back to the default or previous level, the BSD and/or Bj may be lowered by a configured delta level from the current BSD and/or Bj level, and/or the BSD and/or Bj may be set to the next lowest BSD and/or Bj value.

The WTRU may use a non-default BSD temporarily (e.g., only) for the purpose of updating Bj for a given grant (e.g. to flush collected ML data buffered). The WTRU may (e.g., then) revert to using the default PBR. The WTRU may receive DL signalling (e.g. in the scheduling DCI), for example indicating one or more non-default BSD to use for the given grant and/or for data collection LCHs.

BSD of data collection LCHs may be increased when a data collection LCH is restricted from being served on a given grant (e.g. due to any of the reasons herein) and/or when their priorities/PBRs are downgraded (e.g., as the WTRU may need to buffer more bits for the LCH. The BSD increase may be for (e.g., limited to) a period that is configured by the network. The WTRU may revert to the default BSD size, for example after the period.

There may be generalizations related to parameter settings for dynamically changing priority/PBR/BSD. Changing of the priority/PBR/BSD according to the parameters/conditions described herein may be modelled in different ways. Changing of the priority/PBR/BSD may be modelled as a mapping between the different parameter values/thresholds and the priority levels, PBR, and/or BSD. Changing of the priority/PBR/BSD may be modelled as a mapping between the different parameter values/thresholds and a delta value (e.g., amount to add to decrease/increase the priority, and/or the level of steps to increase/decrease the PBR or BSD from the allowable values in the specifications) from the current level/value and/or from a default/initial level configured for the logical channel. Changing of the priority/PBR/BSD may be modelled as a mapping between the different parameter values/thresholds and a scaling factor (e.g., multiplication factor to decrease/increase the priority, PBR, and/or BSD, etc.) from the current value and/or from a default/initial value configured for the logical channel. Changing of the priority/PBR/BSD may be modelled as a formula/association between the change of the parameter value/threshold and the scaling to be applied to the priority/PBR/BSD. For example for every doubling of the outstanding buffer level from a minimum value, the priority level of the logical channel may be incremented by one priority level until the maximum or certain configured priority level is reached.

For (e.g., some of) the parameter value changes that trigger the modification of the priority/PBR/BSD, the WTRU may be configured with a time trigger (TTT). The TTT may be associated with one or more thresholds, for example as described herein. The condition (e.g., data collection volume threshold, and/or WTRU battery level, etc.) may satisfy the associated threshold for the TTT duration, for example before the WTRU applies the action (e.g., to increase/decrease the priority, etc.). The TTT value may be the same for increasing or the decreasing of the priority/PBR/BSD and/or different TTT values may be assigned for increasing and decreasing. Additionally, or alternatively, different TTT values may be assigned for different parameters (e.g., one TTT related to data volume, another TTT related to WTRU battery level, etc.) and/or for the different IEs (e.g., one TTT for priority modifications, another TTT value for PBR modification, and another TTT value for BSD modifications, etc.).

The WTRU may be configured to maintain the priority/PBR/BSD increase/decrease, for example for any of the conditions as herein. Additionally, or alternatively the WTRU may be configured to maintain the priority/PBR/BSD increase/decrease (e.g., only) for a certain configured validity duration (e.g., same configured duration for changes in priority/PBR/BSD modifications or separate durations for changes in priority or PBR or BSD). When for example the configured duration has elapsed, the WTRU may revert the priority/PBR/BSD back to the previous value and/or the default/initial value for that logical channel.

The validity time to maintain the modified value may be different for different levels of change. For example the WTRU may be configured to maintain a one-level priority upgrade/downgrade for a longer validity time duration than a two-level priority upgrade/downgrade. A stepwise approach may additionally or alternatively be configured. For example based on the one or more conditions, the WTRU may have determined to increase the priority level by 3 levels from the default value (e.g., level n+3, where n is the default value). The WTRU may (e.g., then) wait a first validity time duration. The WTRU may (e.g., then) decrease the priority to level n+2 and/or wait a second validity time duration. The WTRU may (e.g., then) decrease the priority level to level n+1 and/or after a third validity time duration has elapsed revert to the default level n.

The different mechanisms described herein for modifying the priority/PBR/BSD and/or associated parameters (e.g., thresholds/timers, etc.) may be the same for all data collection logical channels or may be different for one or more (e.g., each) logical channels. For example for each logical channel there may different parameter values (e.g. buffer thresholds, and/or timer values, etc.) and the buffer level to be compared with the buffer level thresholds may be the only buffer associated with the concerned logical channel. In another example for each logical channel there may be different parameter values (e.g. buffer thresholds, and/or timer values, etc.) and the buffer level to be compared with the buffer level thresholds may be the total buffer level of all data collection logical channels. In another example for each logical channel there may be different parameter values (e.g. buffer thresholds, and/or timer values, etc.) and the buffer level to be compared with the buffer level thresholds may be the total buffer level of a subset of the data collection logical channels (e.g., all the logical channels that belong to the same logical channel group, and/or all logical channels that belong to the same new logical channel grouping discussed herein that is based on the application type, AI/ML functionality, and/or data destination, etc.).

In an example the parameter values (e.g. buffer thresholds, and/or timer values, etc.) may be the same for one or more data collection logical channels (e.g. the same for all, and/or the same for the logical channels belonging to the same logical channel group, etc.) and the buffer level to be compared with the buffer level associated with that particular logical channel. In another example the parameter values (e.g. buffer thresholds, and/or timer values, etc.) may be the same for one or more data collection logical channels (e.g. the same for all, the same for the logical channels belonging to the same (legacy/new) logical channel group, etc. ) and the buffer level to be compared with the total buffer level associated with the group the logical channel belongs to.

There may be simultaneous modification of priority/PRB/BSD. Once a condition for changing priority/PBR/BSD is met for example, the WTRU may be predefined and/or configured with an order by for changing the parameter values. For example the WTRU may change priority and/or PBR. The WTRU may change priority first, PBR first, or both PBR and priority. In some examples the WTRU may modify only one of the parameters at a given time (e.g., to modify priority PBR and BSD may be set to default/initial value).

There may be an association between two or more values. For example the WTRU may be configured with bundled sets and associations between parameters, where if parameter x is changed to value b, then parameter y can be changed to value c or d. In another example, if priority is set to 1, the WTRU may not set the PBR to more than 64 kBps. If for example the WTRU sets the priority to 16, the WTRU may (e.g., then) set the PBR up to 512 kBps.

There may be combined DP-UP LCP. The WTRU may perform a cross-MAC entity LCP procedure, for example where one MAC entity may multiplex UP data and another MAC entity may multiplex DP data and/or data from data collection LCHs. The WTRU may additionally, or alternatively perform a similar LCP procedure, for example when data collection data is configured and/or transmitted on separate bearers from UP/CP bearers. This may be referred to as a combined LCP procedure herein.

In a combined LCP procedure for example, the WTRU may process UP LCHs/data before DP data/LCHs in all or a subset of LCP rounds. The WTRU may process UP LCHs/data together with DP data/LCHs in all or a subset of LCP rounds (e.g., in a combined LCP procedure). The WTRU may include DP LCHs conditionally in all or a subset of LCP rounds (e.g., in a combined LCP procedure).

In a combined LCP procedure for example, there may be one or more resource allocation rounds. For example there may be round 1, round 2, and/or round 3 in an LCP procedure. In round 1 there may be allocation up to PBR×time elapsed since the bucket was updated (e.g. up to Bj). In round 2 there may be allocation of remaining space in the grant by priority order. In round 3 there may be allocation of DP data in remaining space in the grant. Round 3 may be performed for example, when there is extra space in the grant and/or no other UP data buffered after round 2. If round 3 is not performed for example (e.g. no space left in the grant), the WTRU may include an indication (e.g. a MAC CE) indicating that there is DP data buffered or a padding BSR (e.g., possibly for DP LCHs only). A data collection LCH may contend on the grant in round 1, 2, and/or 3, which for example may be configured per LCH. A LCH may (e.g., conditionally) contend in round 1 and/or 2, for example if any of the conditions for a priority and/or PBR upgrade is met (e.g., as herein).

Systems and methods herein may describe a dynamic way of modifying the priority/PBR/BSD at the WTRU, for example based on a set of parameters/thresholds. Additionally, or alternatively, the WTRU may receive an explicit message from the network to change the priority/PBR/BSD of one or more data collection logical channels. The (e.g., explicit) message may be an RRC message (e.g., a dedicated RRC message, and/or a broadcast message, etc.). Additionally, or alternatively, the (e.g., explicit) message may be a MAC CE and/or a DCI. The (e.g., explicit) message may be received in response to the WTRU sending information regarding the collected data. For example the WTRU may indicate that collected data is available or/and the collected data volume has become greater than a certain threshold.

The WTRU may receive a MAC CE that indicates the concerned logical channel(s) and/or the new priority/PBR/BSD. For example, the MAC CE may not explicitly indicate the new priority/PBR/BSD, but may for example indicate whether the value is to be increased/decreased (e.g., to the next higher/lower possible value that can be taken by the priority/PBR/BSD, and/or indicate multiple level changes in just one message).

Parameters (e.g., discussed herein), for example the amount of time, data volumes, the affected data collection bearer(s)/logical channel(s), etc., may be indicated in the message received from the network (e.g., MAC CE). Additionally, or alternatively, the WTRU may be pre-configured with parameter values, for example separately from the message (e.g., in previous messages, MAC/LCH/bearer configurations, values indicated in 3GPP standards, etc.). For example, different MAC CEs may be specified, each associated with one or more (e.g., different) prohibit/validity timers, etc.

1. A wireless transmit/receive unit (WTRU) comprising:
a processor, the processor configured to:
receive configuration information, wherein the configuration information comprises one or more first conditions and one or more second conditions;
receive an uplink (UL) grant;
determine parameters that are associated with a logical channel based on the one or more second conditions;
determine data to transmit based on the parameters associated with the logical channel; and
transmit the data via one or more resources indicated by the UL grant and based on the parameters that are associated with the logical channel.

2. The WTRU of claim 1, wherein the parameter associated with the logical channel indicates a priority of the logical channel, a prioritized bit rate of the logical channel, or a bucket size duration of the logical channel.

3. The WTRU of claim 1, wherein the indication of the one or more second conditions comprises an indication of a volume of collected data.

4. The WTRU of claim 3, wherein the processor is configured to perform one or more of the following when a volume of collected data exceeds a threshold value: increase a priority associated with the logical channel, increase a prioritized bit rate associated with the logical channel, or increase a bucket size duration associated with the logical channel.

5. The WTRU of claim 1, wherein the processor is configured to determine the parameters that are associated with the logical channel based on reception of a data collection reporting request, a congestion level of a network, a buffer level of another logical channel, or a signal level of serving cell.

6. The WTRU of claim 1, wherein the configuration information comprises an indication of the logical channel and a radio bearer associated with the logical channel, and wherein the processor is configured to collect the data and transmit at least one packet data convergence protocol (PDCP) service data unit (SDU) comprising the data to a PDCP entity of the radio bearer associated with the logical channel.

7. The WTRU of claim 1, wherein the configuration information comprises an indication to restrict scheduling of the logical channel, and wherein the processor is configured to perform one or more of the following: not transmit the data based on the UL grant, transmit the data only if there is room in the UL grant after data of other logical channels has been scheduled, or allocate up to a maximum configured percentage of the UL grant to the data.

8. The WTRU of claim 1, wherein the configuration information comprises one or more second conditions, and wherein the processor is configured to collect the data based on the one or more second conditions.

9. The WTRU of claim 1, wherein the processor is configured to determine a restriction level associated with the logical channel based on a volume of collected data.

10. A method performed by wireless transmit/receive unit (WTRU), the method comprising:
receiving configuration information, wherein the configuration information comprises one or more first conditions and one or more second conditions;
receiving an uplink (UL) grant;
determining parameters that are associated with a logical channel based on the one or more second conditions;
determining data to transmit based on the parameters associated with the logical channel; and
transmitting the data via one or more resources indicated by the UL grant and based on the parameters that are associated with the logical channel.

11. The method of claim 10, wherein the parameter associated with the logical channel indicates a priority of the logical channel, a prioritized bit rate of the logical channel, or a bucket size duration of the logical channel.

12. The method of claim 10, wherein the indication of the one or more second conditions comprises an indication of a volume of collected data.

13. The method of claim 12, comprising performing one or more of the following when a volume of collected data exceeds a threshold value: increasing a priority associated with the logical channel, increasing a prioritized bit rate associated with the logical channel, or increasing a bucket size duration associated with the logical channel.

14. The method of claim 10, comprising determining the parameters that are associated with the logical channel based on reception of a data collection reporting request, a congestion level of a network, a buffer level of another logical channel, or a signal level of serving cell.

15. The method of claim 10, wherein the configuration information comprises an indication of the logical channel and a radio bearer associated with the logical channel, and wherein the method comprises collecting the data and transmitting at least one packet data convergence protocol (PDCP) service data unit (SDU) comprising the data to a PDCP entity of the radio bearer associated with the logical channel.

16. The method of claim 10, wherein the configuration information comprises an indication to restrict scheduling of the logical channel, and wherein the method comprises performing one or more of the following: not transmitting the data based on the UL grant, transmitting the data only if there is room in the UL grant after data of other logical channels has been scheduled, or allocating up to a maximum configured percentage of the UL grant to the data.

17. The method of claim 10, wherein the configuration information comprises one or more second conditions, and wherein the method comprises collecting the data based on the one or more second conditions.

18. The method of claim 10, comprising determining a restriction level associated with the logical channel based on a volume of collected data.
